(19) United States
(12) Patent Application Publication
(10) Pub. No.: US 2009/0190471 A1
(43) Pub. Date: Jul. 30, 2009

(54) Method and Apparatus for Optimized Session Setup with Network-Initiated QoS Policy Control

(76) Inventors: Arungundram C. Mahendran, San Diego, CA (US); Jun Wang, La Jolla, CA (US); Haipeng Jin, San Diego, CA (US)

Correspondence Address: QUALCOMM INCORPORATED, 5775 MOREHOUSE DR., SAN DIEGO, CA, 92121, US

(21) Appl. No.: 12/350,711

(22) Filed: Jan. 8, 2009

Related U.S. Application Data
(60) Provisional application No. 61/020,359, filed on Jan. 10, 2008.

(51) Int. Cl. H04L 12/26; H04W 4/00

(52) U.S. Cl. 370/230.1; 370/328

(57) ABSTRACT

Apparatus and methods operable by a network in configuring quality of service (QoS) for an access terminal are operable to receive, at a network, a request for packet data access from an access terminal. The apparatus and methods are further operable to determine, at the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application. Additionally, the apparatus and methods are operable to establish the at least one reservation link with the access terminal, prior to initiation of the at least one application on the access terminal, wherein the at least one reservation link includes the initial QoS parameters for the at least one application.

### CLAIM OF PRIORITY UNDER 35 U.S.C. §119

The present Application for Patent claims priority to Provisional Application No. 61/020,359 entitled “METHOD AND APPARATUS FOR OPTIMIZED SESSION SETUP WITH NETWORK-INITIATED QoS AND POLICY CONTROL” filed Jan. 10, 2008, and assigned to the assignee hereof and hereby expressly incorporated by reference herein.

### REFERENCE TO CO-PENDING APPLICATIONS FOR PATENT

The present Application for Patent is related to co-pending U.S. patent application Ser. No. 12/136,538 entitled “QUALITY OF SERVICE INFORMATION CONFIGURATION” filed Jun. 10, 2008, assigned to the assignee hereof, and expressly incorporated by reference herein.

### BACKGROUND

1. Field

The following description relates generally to wireless communications and, more particularly, to network-based configuration of quality of service information.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP LTE systems, and orthogonal frequency division multiple access (OFDMA) systems.

In connecting to a network, an access terminal establishes a session. The session may have various communications parameters, one of which is Quality of Service (QoS). In some scenarios, Quality of Service (QoS) is setup after a round-trip of signaling exchanges between communicating endpoints. This may lead to unnecessary call setup delay and bad user experience.

Thus, improvements in establishing QoS for connectivity to a network are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method operable by a network in configuring quality of service (QoS) for an access terminal comprises receiving, at a network, a request for packet data access from an access terminal. The method further comprises determining, by the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application. Additionally, the method comprises establishing the at least one reservation link with the access terminal, prior to initiation of the at least one application on the access terminal, wherein the at least one reservation link includes the initial QoS parameters for the at least one application.

In another aspect, at least one processor operable by a network in configuring quality of service (QoS) for an access terminal comprises a first module for receiving, at a network, a request for packet data access from an access terminal. The at least one processor further comprises a second module for determining, by the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application. Additionally, the at least one processor comprises a third module for establishing the at least one reservation link with the access terminal, prior to initiation of the at least one application on the access terminal, wherein the at least one reservation link includes the initial QoS parameters for the at least one application.

In a further aspect, a computer program product operable by a network in configuring quality of service (QoS) for an access terminal comprises a computer-readable medium comprising a plurality of codes. The codes comprise a first set of codes for causing a computer to receive, at a network, a request for packet data access from an access terminal. The codes also comprise a second set of codes for causing the computer to determine, at the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application. Additionally, the codes comprise a third set of codes for causing the computer to establish the at least one reservation link with the access terminal, prior to initiation of the at least one application on the access terminal, wherein the at least one reservation link includes the initial QoS parameters for the at least one application.

In yet another aspect, a network apparatus operable in configuring quality of service (QoS) for an access terminal comprises means for receiving, at a network, a request for packet data access from an access terminal. The network apparatus further comprises means for determining, by the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application. Additionally, the network apparatus comprises means for establishing the at least one reservation link with the access terminal, prior to initiation of the at least one application on the access terminal, wherein the at least one reservation link includes the initial QoS parameters for the at least one application.

In a further aspect, a network apparatus operable for configuring quality of service (QoS) for an access terminal comprises a receiver operable to receive a request for packet data access to a network from an access terminal. The network apparatus further comprises a policy function operable to determine, at the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application. Additionally, the network apparatus comprises an access network operable to establish the at least one reservation link with the access terminal, prior to initiation of the at least one application on the access terminal, wherein the at least one reservation link includes the initial QoS parameters for the at least one application.

In some aspects of the apparatus and methods described herein, the initial QoS policy configuration may be associated with a plurality of reservation links for a plurality of applications on the access terminal. Further, the establishing of the at least one reservation link may further comprise turning the reservation on or off. Additionally, the apparatus and methods described herein may further include receiving a reservation link activation request from the access terminal or determining by the network that the at least one reservation link should be activated, and turning on the reservation in response thereto. The turning on of the at least one reservation link may be based on a call originated from or terminated by the access terminal.

In some aspects of the apparatus and methods described herein, the preconfigured information comprises subscriber information including a QoS user profile. Further, in some aspects, the initial QoS parameters may be derived from the QoS user profile based on an access network used by the access terminal. For example, the initial QoS parameters may comprise at least one of maximum authorized aggregate bandwidth for best effort traffic, authorized flow profile IDs for each direction, maximum per flow priority, allowed differentiated services markings, inter-user priority for best effort, mapping between QoS claims (such as QoSFlowProfileID or QoS Class Indicator (QCI)) and Differentiated Services Code Point (DSCP), and mapping between QoS class and Token Bucket Parameters

Additionally, in some aspects, the initial QoS policy configuration comprises policy rules for the at least one application and each policy rule comprises at least one of full or partial packet filters and the initial QoS parameters for the at least one application.

In some aspects of the apparatus and methods described herein, the determining of the initial QoS policy configuration occurs on the network without receiving input from the access terminal. In other words, the QoS policy determination is network determined and network initiated.

Further, in some aspects, the initial QoS configuration may be updated with new QoS parameters subsequent to establishing the communication link with the access terminal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an aspect of a system for session setup with network-initiated Quality of Service (QoS) and policy control;

FIG. 2 is a schematic diagram of an aspect of a policy function and subscriber database utilized in the system of FIG. 1;

FIG. 3 is a schematic diagram of an aspect of a portion of an architecture in which the system of FIG. 1 may operate;

FIG. 4 is a schematic diagram of an aspect of a portion of an architecture in which the system of FIG. 1 may operate;

FIG. 5 is a flowchart of an aspect of a method of network-initiated Quality of Service (QoS) and policy control;

FIGS. 6A and 6B are corresponding portions of a message flow diagram of an aspect of network-initiated Quality of Service (QoS) and policy control;

FIGS. 7A and 7B are corresponding portions of a message flow diagram of an aspect of network-initiated Quality of Service (QoS) and policy control; and

FIG. 8 is a schematic diagram of the access terminal and various network entities.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described aspects include methods and apparatus for network preconfiguration of QoS parameters in a communication channel triggered by establishment of packet data access by an access terminal with the network. The network-determined and network-initiated pre-establishment of the QoS parameters are for one or more reservation links, which each relate to a corresponding one or more applications resident on the access terminal. Further, the QoS parameters established based upon establishment of the packet data access are based on QoS-related information stored in the network and applied to the given access scenario. Additionally, after establishment, the one or more reservation links may be turned on or off by either the network or by the access terminal. Thus, the described aspects improve the efficiency in setting up a call once the corresponding application on the access terminal is initiated.

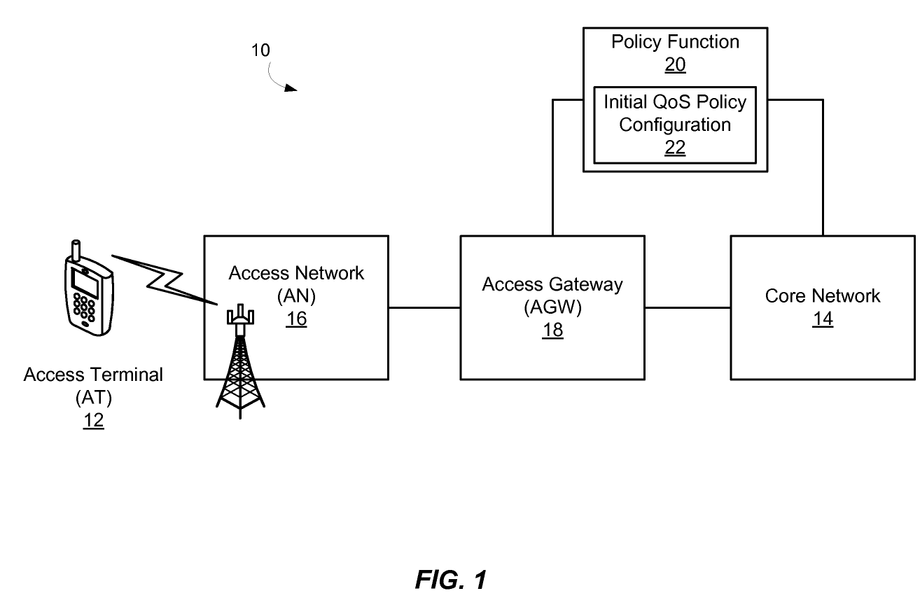

Referring to FIG. 1, in one aspect, a system 10 for session setup with network-initiated Quality of Service (QoS) and Policy Control includes an access terminal (AT) 12 that can communicate with a core network 14 via an access network (AN) 16 and an access gateway (AGW) 18. AT 12 may be stationary or mobile and may also be referred to as a mobile station, a terminal, a subscriber unit, a subscriber station, etc. AT 12 may be a cellular phone, a personal digital assistant (PDA), a wireless device, a wireless modem, a laptop computer, a telemetry device, a tracking device, etc. Further, AT 12 may communicate with one or more base stations and/or one or more access points in AN 16. AN 16 provides radio communication for ATs located within its coverage area. AN 16 may also be referred to as a radio network, a radio access network, etc. AN 16 may include base stations, access points, network controllers, and/or other entities, as described below. AGW 18 is a network entity that ensures proper routing of communication packets in system 100, as well as enforcing QoS and policy control between networks.

System 10 further includes a policy function 20 operable to pre-establish an initial QoS policy configuration 22 for one or more applications or services utilized in a communication session between AT 12, AN 16 and core network 14. In particular, policy function 20 is operable to set up initial QoS policy configuration 22, prior to initialization of the respective application or service on AT 12, based on AN 16 receiving from AT 12 a request to establish a packet data session. Specifically, triggered by or based on the establishment of the packet data session, policy function 20 is operable to determine initial QoS policy configuration 22. For example, initial QoS policy configuration 22 may include, but is not limited to, policy rules for the at least one application and each policy rule comprises at least one of full or partial packet filters and the initial QoS parameters for the at least one application. Specifically, at least one reservation link, e.g. a QoS pipe, is pre-established for the at least one application. Although established, each reservation link may be controllably turned on or turned off, e.g. activated or not activated. As such, a communication channel or single, logical pipe may be established with one or more logical QoS pipes or reservation links to service communications between AT 12 and AN 16. Accordingly, based on the network-determined and network-initiated pre-establishment of initial QoS policy configuration 22, system 100 advantageously can reduce call set up for the respective application or service once it is initialized, and further advantageously can initially apply relevant QoS parameters specific to the AT 12, the user of the AT, and/or the AN 16 or core network 14.

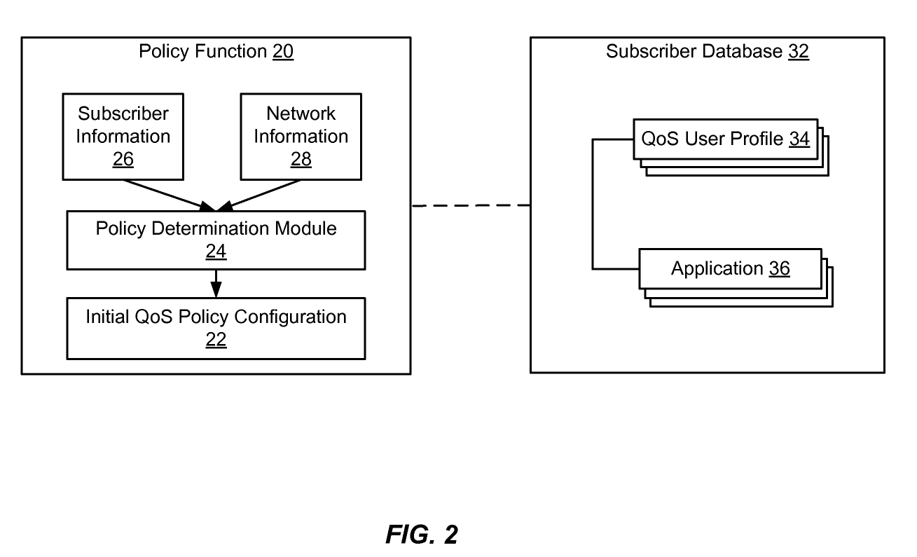

For example, referring to FIG. 2, in one aspect, policy function 20 includes a policy determination module 24 operable to generate initial QoS policy configuration 22 based on subscriber information 26 and/or network information 28. Policy determination module 24 may include hardware, software, firmware, executable instructions, etc., operable to apply a function, algorithm, rule, heuristic, etc., to the respective subscriber information 26 and/or network information 28 in order to produce initial QoS policy configuration 22. Further, initial QoS policy configuration 22 may be specific to the given combination of AT 12 and corresponding network components, such as one or more of AN 16, AGW 18 and/or core network 14. Further, in system 100, policy function 20 can allow QoS differentiated IP services (such as VoIP and other data services) to be defined and specified independently within the confines of the air interface, e.g. the communication link between AT 12 and AN 16. In system 100, the air interface can support multiple IP flows, e.g. multiple reservation links. And, each IP flow can be mapped onto a single reservation link. Accordingly, initial QoS policy configuration 22 may apply to one or more reservation links corresponding to one or more IP flows, which may in turn relate to a given application on AT 12. Further, policy function 20 may convert the initial information or rules into AN-specific rules or parameters, which define initial QoS policy configuration 22. Thus, initial QoS policy configuration 22 may be specific to the specific combination of the AT, the access network, and a given application on the AT.

Further, for example, subscriber information 26 and/or network information 28 is information relevant to determining one or more QoS parameters to an IP flow. For example, network information 28 may include any QoS-related parameters or characteristics corresponding to AN 16 and/or core network 14, such as bandwidth, delay requirements, handling priority, service class, and loss requirements. Further, for example, subscriber information 26 may include all or a part of a subscriber profile 30, which may be obtained from a subscriber database 32 on the network. Subscriber database 32 may maintain subscriber profile 30 for each subscriber to a network. Further, subscriber profile 30 may include parameters defining AT-specific capabilities and/or allowances, also referred to as a QoS user profile 34, with respect to one or more applications 36 operable on the respective AT. For example, applications 36 may include, but are not limited to, applications such as Voice Over Internet Protocol (VoIP) applications and Internet Protocol Multimedia Subsystem (IMS) applications. Further, for example, QoS user profile 34 may include, but is not limited to, parameters such as maximum authorized aggregate bandwidth for best effort traffic, authorized flow profile IDs for each direction, maximum per flow priority, allowed differentiated services markings, inter-user priority for best effort, mapping between QoS class (such as QoSFlowProfileID or QoS Class Indicator (QCI)) and Differentiated Services Code Point (DSCP), and mapping between QoS claims (such as QoSFlowProfileID or QCI) and policing rules such as Token Bucket Parameters including, but not limited to, peak rate, bucket size, token rate, maximum latency, etc. In addition, other relevant QoS characteristics can be implemented in accordance with aspects disclosed herein.

Accordingly it should be understood that initial QoS policy configuration 22 may include static rules obtained from subscriber information 26 and/or network information 28, parameters derived from this information, or a combination of both. Policy determination module 24 is operable to obtain subscriber information 26 and/or network information 28, determine what is allowed and what is capable of being implemented, and generate access network-specific rules and/or policies based on such determinations in order to pre-establish a QoS reservation for one or more applications on AT 12. The QoS reservation can be established, but may be turned “off,” or in other words may be not be activated, until initiation of the respective application on AT 12, at which point the reservation may be turned “on.” Accordingly, AGW 18 enforces the QoS policies for communications between AT 12 and AN 16 and/or core network 14 associated with activated QoS reservations.

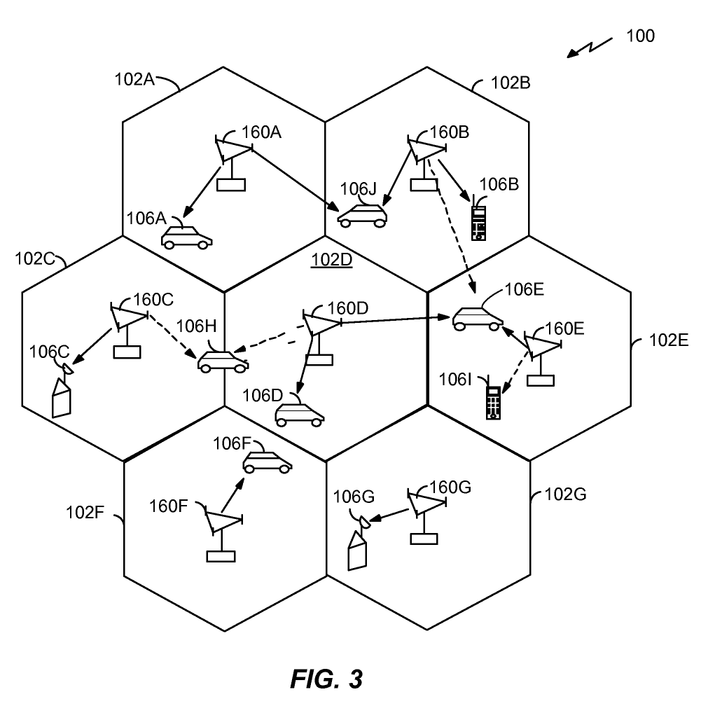

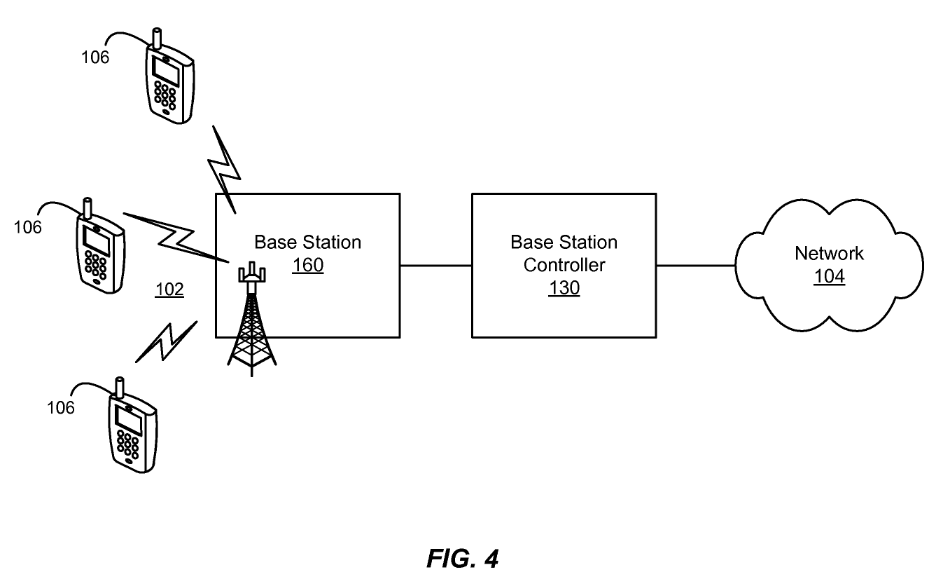

Referring to FIGS. 3 and 4, an example of a cellular communication system 100 operable to implement the described apparatus and methods includes one or more cells 102A-102G that each include a corresponding base station 160A-160G, and wherein one or more access terminals (AT) 106A-106G may communicate in a respective cell 102 with a respective base station 160 to connect to each other, to a wireline telephone, or to another network 104 such as a packet-based network like the Internet. Communication systems may use a single carrier frequency or multiple carrier frequencies. In wireless communication systems, a channel consists of a forward link (FL) for transmissions from a respective base station 160 to a respective AT 106 and a reverse link (RL) for transmissions from a respective AT 106 to a respective base station 160. Each link may incorporate a different number of carrier frequencies. Further, a channel is defined as the set of communication links for transmissions between the AN 120 and the AT's 106 within a given frequency assignment.

System 100 may be a code division multiple access (CDMA) system having a High Data Rate, HDR, overlay system, such as specified in the HDR standard. In HDR Systems, the HDR base stations 160 may also be described as access points (AP) or modem pool transceivers (MPTs). An HDR subscriber station 106, referred to herein as an access terminal, may communicate with one or more HDR base stations 160, also referred to as modem pool transceivers (MPTs). An access terminal 106 transmits and receives data packets through one or more modem pool transceivers 160 to a HDR base station controller 130 (FIG. 4), also referred to as a modem pool controller 130 (MPC), by way of the air interface. Modem pool transceivers 160 and modem pool controllers 130 are parts of AN 120. The AN 120 may include multiple sectors, wherein each sector provides at least one channel. The AN 120 may be further connected to additional networks 104 outside the AN 120, such as a corporate intranet or the Internet, and may transport data packets between each AT 106 and such outside networks 104.

Referring more specifically to FIG. 4, a base station controller 130 can be used to provide an interface between network 104 and all base stations 160 dispersed throughout a geographic region. For ease of explanation, only one base station 160 is shown. The geographic region is generally subdivided into smaller regions known as cells 102. Each base station 160 is configured to serve all ATs 106 in its respective cell. In some high traffic applications, the cell 102 may be divided into sectors with a base station 160 serving each sector. In the described exemplary embodiment, three ATs 106A-C are shown in communication with the base station 160. Each AT 106A-C may access the network 104, or communicate with other ATs 106, through one or base stations 160 under control of the base station controller 130.

In operation, the apparatus described above are operable to optimize session setup with network initiated QoS and policy control. In the prior art, QoS is setup after a round-trip of signaling exchanges between communicating endpoints. Such exchanges may lead to unnecessary call setup delay and bad user experience. The present methods and apparatus operate to set up QoS in advance, with network initiated QoS and Policy control. Advance setup of QoS leads to a reduction in the number of session setup steps and results in a user experiencing much shorter call setup time for calls, e.g. VoIP or multimedia calls. Further, the advance set up helps reduce the number of steps required when an actual session is set up, and thus greatly shortens call setup delay.

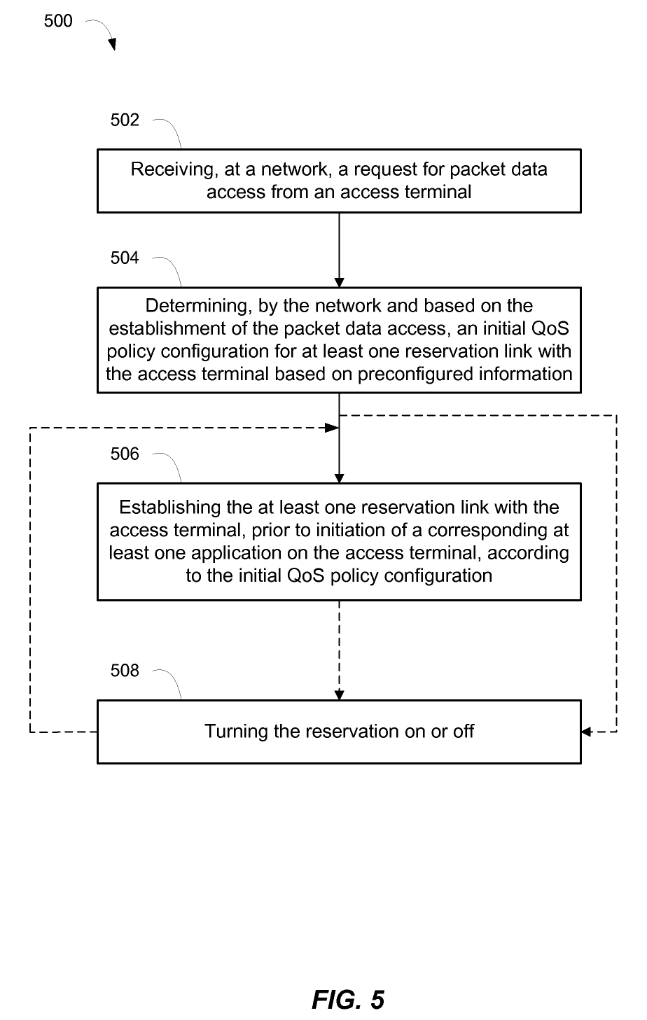

Referring to FIG. 5, in one aspect, a method 500 operable by a network for configuring quality of service (QoS) for an access terminal includes receiving, at a network, a request for packet data access from an access terminal (Block 502). For example, the request for packet data access may be part of establishment of a packet data session between the access terminal and an access network.

The method further includes determining, by the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application (Block 504). In other words, the network is triggered to set up QoS in advance based on the establishment of packet data access by the access terminal with the network. The access terminal does not provide any input to the network in determining the initial QoS policy configuration—the determination is network-based according to the preconfigured information at the network. Also, the preconfigured information includes subscriber information and/or network information, both having QoS-related parameters, and both available within the network. For example, the network may include a policy function operable, upon being notified of the initiation of a communication link by the access terminal, to obtain subscriber information corresponding to the access terminal and/or network information corresponding to the respective access network, wherein each set of information includes relevant QoS parameters. For example, the subscriber information may be obtained from a subscriber database having a QoS user profile for one or more applications resident on the access terminal. Further, the policy function may include a policy determination module operable to analyze the subscriber information and/or the network information, determine what QoS parameters may be granted based on access terminal QoS desires and/or requirements and network capabilities, and generate the initial QoS policy configuration. The initial QoS policy configuration may be specific to the given combination of characteristics of the access terminal and the access network. Further, the initial QoS policy configuration may include one or more of static QoS rules, such as may be present in the QoS user profile, and derived QoS rules, which may be some function of a rule or parameter in the QoS user profile applied to the specific access network being utilized.

Additionally, the method further includes establishing the at least one reservation link with the access terminal, prior to initiation of the at least one application on the access terminal, wherein the at least one reservation link includes the initial QoS parameters for the at least one application (Block 506). Accordingly, by setting up in advance the reservation link with the initial QoS parameters, once an application on the access terminal is invoked, the reservation link and QoS parameters are already established, thereby reducing the call set up time for the application.

Optionally, the method may further include turning the reservation on or off (Block 508). For example, the reservation for the communication flow may be turned on or off upon initial establishment of the communication link, or after the initial establishment, such as by invoking of the corresponding application on the access terminal. Further, turning the reservation off, or holding the reservation in an off state, includes maintaining the QoS parameters in association with the link but not using radio network resources for the particular communication flow to which the QoS parameters are associated. On the other hand, turning the reservation on, or holding the reservation in an on state, includes applying the QoS parameters to radio network resources to govern the communications between the corresponding application and the access network for the respective communication flow.

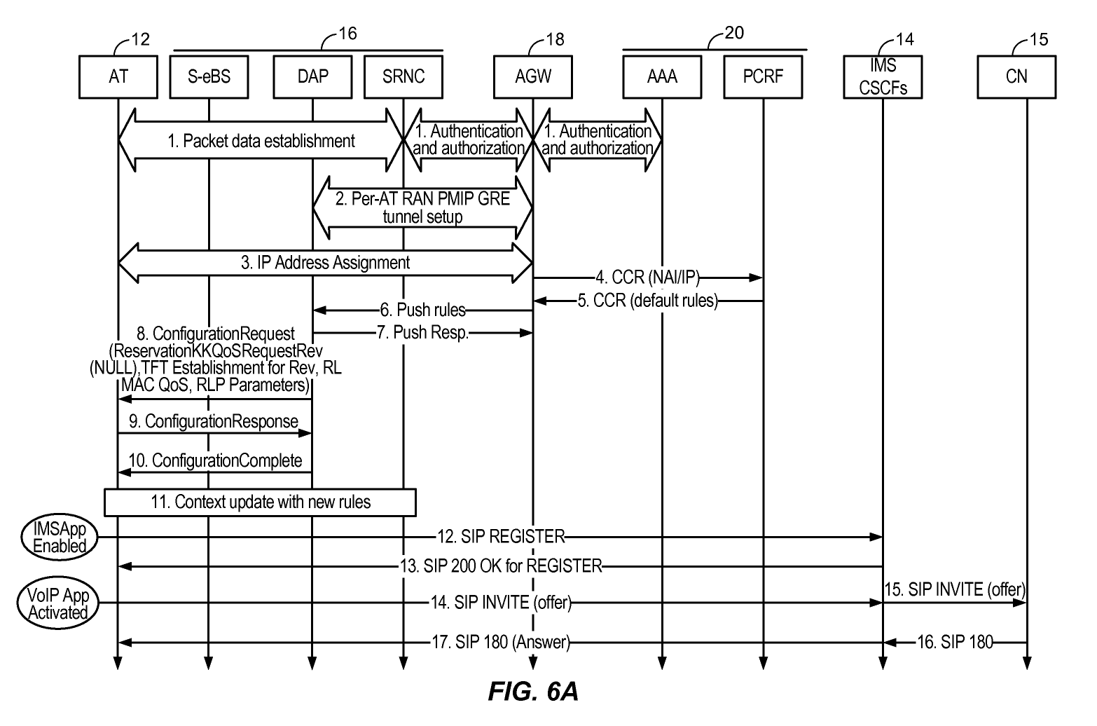

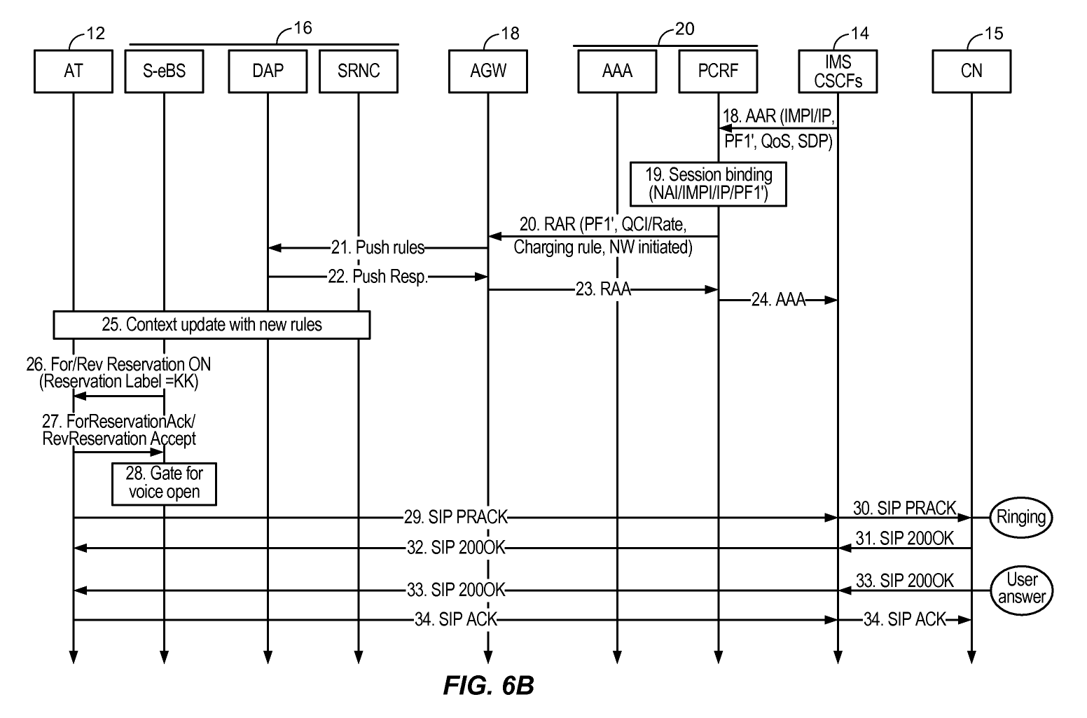

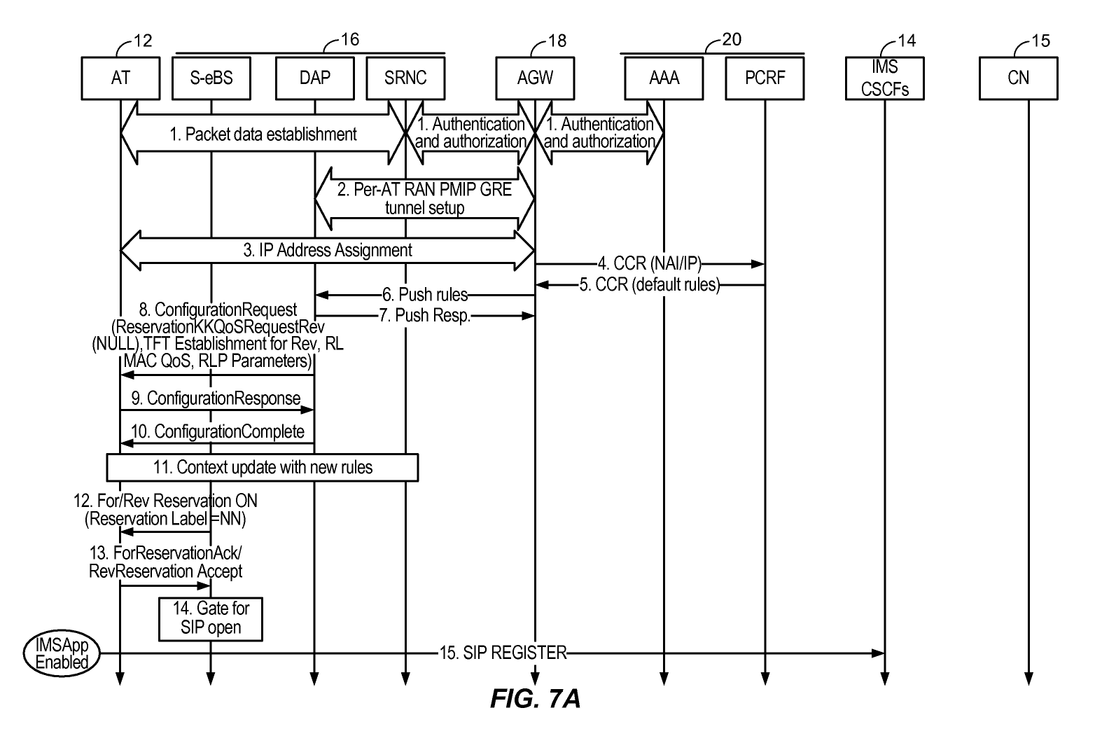

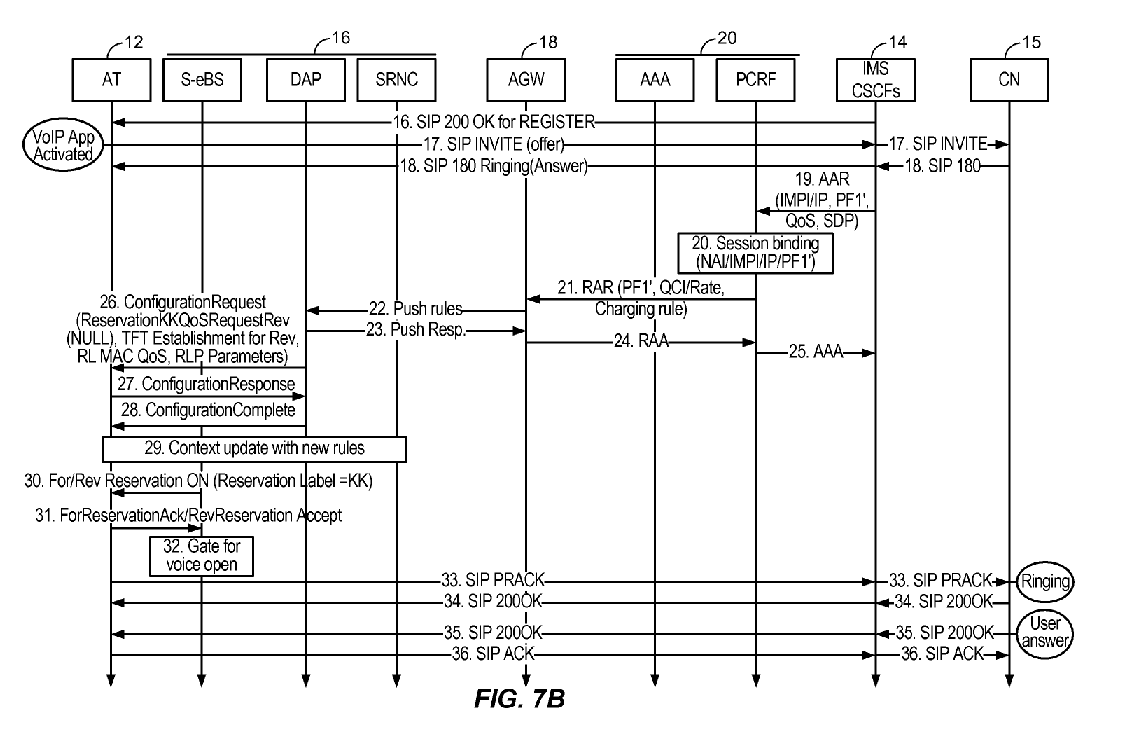

Additionally, referring to FIGS. 6A, 6B, 7A and 7B, aspects of specific examples in an Ultra Mobile Broadband (UMB) network include respective message flows for carrying out the above-described methods. It should be understood, however, that the described aspects are not limited to a UMB system architecture, but instead may be applied to any system architecture, such as but not limited to 3GPP, 3GPP2, Long Term Evolution (LTE), WCDMA, wired networks, etc. Further, in FIGS. 6A, 6B, 7A and 7B, serving AN 16 includes a serving enhanced base station (S-eBS), a data access point (DAP), and a signaling radio network controller (SRNC). Additionally, the policy function 20 includes an authentication and authorization (AAA) server and a policy and charging rules function (PCRF). The core network 14 includes an IP Multimedia Subsystem (IMS) network and its various components, such as a call state control function (CSCF). Additionally, the network architecture includes a corresponding node (CN) 15, which is the other end point of the communication originating from or terminating at AT 12.

Referring to FIGS. 6A and 6B, an aspect of a message flow in a procedure for pre-configuring (Steps 4-10), by a network, the QoS for both an IMS application and a VoIP application for AT connectivity includes the following steps and actions.
1-3. The AT performs successful access authentication and authorization. During the Access Authentication and Authorization procedures, the QoS User Profile is sent to the SRNC. The SRNC sends the QoS User Profile to the eBS as session information. The tunnel between DAP and AGW is established. The IP address is also assigned.
4. Since dynamic policy and charging control (PCC) is supported, the AGW sends a credit control request (CCR) to establish a policy control session (Ty session) with the PCRF after IP address assignment.
5. The PCRF acknowledges the CCR request with credit control answer (CCA) and static policies with default rules may be included in this acknowledgment. The default rules include the initial QoS policy configuration having initial QoS parameters. Further, the policy function 20 may derive the initial QoS policy configuration from the QoS user profile, and further based on the access network.
6.-7. The AGW pushes all the related policy and charging control (PCC) information, including the initial QoS policy configuration, to the AN (or the DAP in this case) and receives a confirmation response from the AN.
8. Based on the PCC information, including the initial QoS policy configuration, the AN may need to set up QoS for certain applications (e.g. SIP signaling). The AN sends a Configuration Request to the AT containing ReservationKKQoS Request and traffic flow template (TFT) corresponding to the communication flow, e.g. reservation link, for one or more respective applications corresponding to the initial QoS policy configuration.
9. The AT sends w Configuration Response message to the AN.
10. The AN sends Configuration Complete message to the AT.
11. AT and all the AN entities (eBS, DAP, SRNC) are updated with the latest PCC information, including the initial QoS policy configuration, using context update procedures.
12.-13. After IMS application is enabled, the AT performs registration with IMS network.
14.-15. When the user invokes an application (e.g. VoIP), the AT sends an INVITE message to the intended destination, e.g. CN 15, with session description protocol (SDP) information based on the application. The application is not QoS-aware and thus does not indicate QoS resource availability information in the INVITE, assuming that the network will set up proper QoS. It should be noted that this example is for an AT-originated case, however, an AT-terminated case is also contemplated where the direction of the messages is reversed.
16.-17. The corresponding node replies to the SIP INVITE message, for example, with a reliable 180 Ringing provisional response. This response contains the SDP answer from the CN.
18. Upon receiving the 180 Ringing response, the P-CSCF sends an authentication and authorization request (AAR) to the PCRF based on Tx procedures to communicate the application information to the PCRF.
19. The PCRF performs session binding and correlates the Tx session to the corresponding Ty session established in Step 4.
20. The PCRF authorizes the QoS required for the application and sends related PCC rules to the AGW based on Ty procedures.
21.-22. The AGW forwards all PCC rules to the AN.
23.-24. The AGW acknowledges the PCC rules received from the PCRF and the PCRF acknowledge the application information received from the P-CSCF.
25. AT and all the AN entities (eBS, DAP, SRNC) are updated with the latest PCC information using context update procedures. According, this step includes updating the initial QoS policy configuration with new QoS parameters, if applicable.

26. The AN sends a Reservation ON Request to the AT including the granted QoS. So, at this point, the reservation of the communication flow with the initial QoS policy configuration had been made, but was not active. So, the AN is activating the reservation.
27. The AT sends a ForReservationAck/RevReservationAccept message to the AN.
28. The gate for the application media (e.g. voice) is now open and subject to the QoS policies and rules as managed by the AGW.
29.-30. In parallel to Steps 18-28, the AT acknowledges the reliable response from the CN. The called user is alerted of the incoming call from this AT.
31.-34. The called user finally answers the call. The CN sends a 200OK message and receives an acknowledgement (ACK) message from the AT. The session is now established.

Referring to FIGS. 7A and 7B, an aspect of a message flow in a procedure for initiating quality of service by a network for AT connectivity includes the following steps and actions. In the aspect of FIGS. 7A and 7B, the QoS for an IMS application is pre-configured (Steps 4-10), while the QoS of a VoIP application is later configured (Steps 26-28). Further, it should be noted that the description of the steps in FIGS. 6A and 6B above may also relate to the corresponding steps of FIGS. 7A and 7B, even though there may be a different order.
1.-3. The AT performs successful access authentication and authorization. During the Access Authentication and Authorization procedures, the QoS User Profile is sent to the SRNC. The SRNC sends QoS User Profile to the eBS as session information. The tunnel between DAP and AGW is established. The IP address is also assigned.
4. Since SBBC is supported, the AGW sends CCR request to establish policy control session (Ty session) with the PCRF after IP address assignment.
5. The PCRF acknowledges the CCR request with CCA and static policies with default rules may be included in this acknowledgment. It should be noted that these defaults rules, as explained further below, may only include the initial QoS policy configuration and the initial QoS parameters related to a SIP set up, and VoIP parameters are configured later.
6.-7. The AGW pushes all the related PCC information to the AN (DAP in this case) and receives response from the AN.
8. Based on the PCC rules, the AN may need to set up QoS for certain applications (e.g. SIP signaling). The AN sends Configuration Request to the AT containing ReservationKKQoS Request and TFT.
9. The AT sends Configuration Response to the AN.
10. The AN sends ConfigurationComplete to the AT.
11. AT and all the AN entities (eBS, DAP, SRNC) are updated with the latest PCC information using context update procedures.
12. The AN sends Reservation ON Request to the AT including the granted QoS.
13. The AT sends ForReservationAck/RevReservationAccept to the AN.
14. The gate for the application (e.g. SIP signaling) is now open.
15.-16. After IMS application is enabled, the AT performs registration with IMS network.
17. When the user invokes an application (e.g. VoIP), the AT sends INVITE to the intended destination with SDP information based on the application. The application is not QoS-aware and thus does not indicate QoS resource availability information in the INVITE, assuming that the network will set up proper QoS. In this case, since the initial QoS policy configuration did not include initial QoS parameters relating to the VoIP application, a complete set up is initiated.
18. The corresponding node replies to the SIP INVITE message with a reliable 180 Ringing provisional response. This response contains the SDP answer from the CN.
19. Upon receiving the 180 Ringing response, the P-CSCF sends AAR to the PCRF based on Tx procedures to communicate the application information to the PCRF.
20. The PCRF performs session binding and correlate the Tx session to the corresponding Ty session established in Step 4.
21. The PCRF authorizes the QoS required for the application and sends related PCC rules to the AGW based on Ty procedures.
22.-23. The AGW forwards all PCC rules to the AN.
24˜25. The AGW acknowledges the PCC rules received from the PCRF and the PCRF acknowledge the application information received from the P-CSCF.
26. The AN sends Configuration Request to the AT containing ReservationKKQoS Request and TFT.
27. The AT sends Configuration Response to the AN.
28. The AN sends ConfigurationComplete to the AT.
29. AT and all the AN entities (eBS, DAP, SRNC) are updated with the latest PCC information using context update procedures.
30. The AN sends Reservation ON Request to the AT including the granted QoS.
31. The AT sends ForReservationAck/RevReservationAccept to the AN.
32. The gate for the application media (e.g. voice) is now open.
33.-34. In parallel to Steps 19-32, the AT acknowledges the reliable response from the CN. The called user is alerted of the incoming call from this AT.
35.-36. The called user finally answers the call. The CN sends 200OK and receives ACK from the AT. The session is now established.

In some aspects, steps 19-32 occur in parallel to steps 17 and 18.

In some aspects, in steps 6-14 QoS is pre-setup and when the application is invoked, thereby shortening the procedure.

In some aspects, in step 11, all new rules are updated to the network access entities.

Some aspects include method and apparatus for initiating network policy push and network policy setup before offer/answer is completed.

Some aspects include method and apparatus for initiating network policy push and network policy setup after offer/answer is completed.

Some aspects include method and apparatus for initiating network policy push and network policy setup before offer/answer is completed on both the originating and terminating sides.

Some aspects include method and apparatus for initiating network policy push and network policy setup after offer/answer is completed on both the originating and terminating sides.

Some aspects include methods and apparatus for setting up network initiated QoS for real time apps in advance on both the originating and terminating sides.

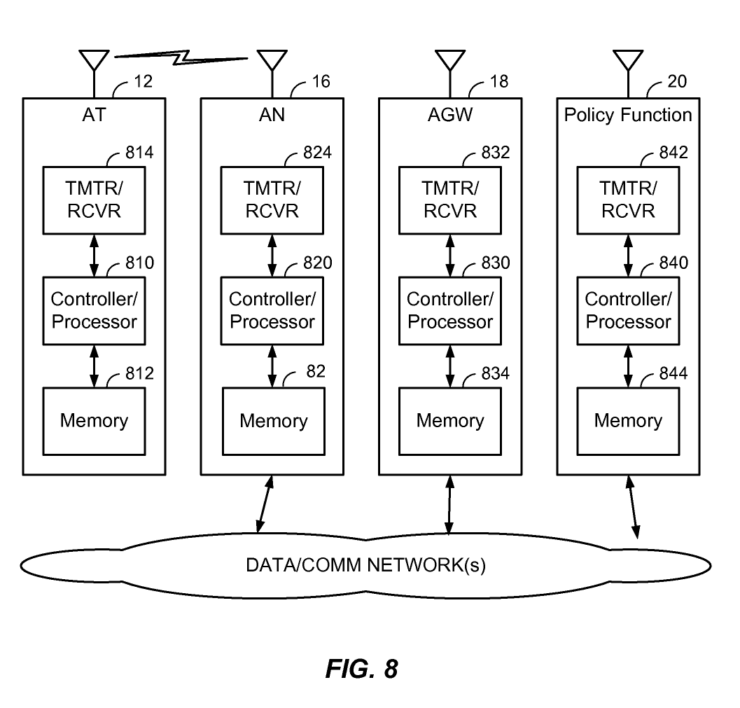

Moreover, referring to FIG. 8, one example of components of the network includes AT 12, access network 16, AGW 18, policy function 20 and their components. For simplicity, FIG. 8 includes one controller/processor, one transmitter/receiver (TMTR/RCVR) and one memory for each entity. In general, each entity may include any number of controllers, processors, memories, transmitters, receivers, communication units, etc. Further, it should be noted that the functionality described herein may be implemented by the respective controller/processor of each component, such as by executing computer readable instructions. Such instructions may be stored in a respective memory, or may be implemented in one or more modules within the respective processor.

On the downlink, base stations in access network 16 transmit traffic data, messages/signaling, and pilot to ATs within their coverage area. These various types of data are processed by a processor 820 and conditioned by a transmitter 824 to generate downlink signals, which are transmitted to the ATs. At AT 12, the downlink signals from base stations are received via an antenna, conditioned by a receiver 814, and processed by a processor 810 to obtain information for registration, call establishment, etc. Processor 810 may perform processing for AT 12 as described above. Memories 812 and 822 store program codes and data for AT 12 and access network 116, respectively, for performing the functionality described herein.

On the uplink, AT 12 may transmit traffic data, messages/signaling, and pilot to base stations in access network 16. These various types of data are processed by processor 810 and conditioned by transmitter 814 to generate an uplink signal, which is transmitted via the AT antenna. At access network 16, the uplink signals from AT 12 and other ATs are received and conditioned by receiver 824 and further processed by processor 820 to obtain various types of information, e.g., data, messages/signaling, etc. Access network 16 may communicate with other network entities via transmitter/receiver 824.

Within AGW 18, a processor 830 performs processing for the AGW, a memory 832 stores program codes and data for the AGW, and a transmitter/receiver 834 allows the AGW to communicate with other entities. Processor 830 may perform processing for AGW as described above.

Within policy function 20, a processor 840 performs processing for the policy function, a memory 842 stores program codes and data for the policy function, and a transmitter/receiver 844 allows the policy function to communicate with other entities. Processor 840 may perform processing for policy function 20 as described above.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method operable by a network in configuring quality of service (QoS) for an access terminal, comprising:
receiving, at a network, a request for packet data access from an access terminal;
determining, by the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application; and
establishing the at least one reservation link with the access terminal, prior to initiation of the at least one application on the access terminal, wherein the at least one reservation link includes the initial QoS parameters for the at least one application.

2. The method of claim 1, further comprising associating the initial QoS policy configuration with a plurality of reservation links for a plurality of applications on the access terminal.

3. The method of claim 2, wherein establishing the communication link further comprises turning on the at least one reservation link.

4. The method of claim 2, wherein establishing the communication link further comprises turning off the at least one reservation link.

5. The method of claim 2, further comprising receiving a reservation link activation request from the access terminal or determining by the network that the reservation link should be activated, and further comprising turning on the reservation link.

6. The method of claim 5, wherein the reservation link activation request is based on a call originated by the access terminal.

7. The method of claim 5, wherein the reservation link activation request is based on a call terminated by the access terminal.

8. The method of claim 1, wherein the preconfigured information comprises subscriber information including a QoS user profile.

9. The method of claim 8, further comprising deriving the initial QoS parameters from the QoS user profile based on an access network used by the access terminal.

10. The method of claim 1, wherein the initial QoS policy configuration comprises policy rules for the at least one application and each policy rule comprises at least one of full or partial packet filters and the initial QoS parameters for the at least one application.

11. The method of claim 1, wherein the initial QoS parameters comprise at least one of maximum authorized aggregate bandwidth for best effort traffic, authorized flow profile IDs for each direction, maximum per flow priority, allowed differentiated services markings, inter-user priority for best effort, mapping between QoS class and Differentiated Services Code Point (DSCP), and mapping between QoS class and Token Bucket Parameters.

12. The method of claim 1, wherein the determining occurs without input from the access terminal.

13. The method of claim 1, further comprising updating the initial QoS configuration with new QoS parameters subsequent to establishing the reservation link.

14. At least one processor operable by a network in configuring quality of service (QoS) for an access terminal, comprising:
a first module for receiving, at a network, a request for packet data access from an access terminal;
a second module for determining, by the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application; and
a third module for establishing the at least one reservation link with the access terminal, prior to initiation of the at least one application on the access terminal, wherein the at least one reservation link includes the initial QoS parameters for the at least one application.

15. A computer program product operable by a network in configuring quality of service (QoS) for an access terminal, comprising:
a computer-readable medium comprising:
a first set of codes for causing a computer to receive, at a network, a request for packet data access from an access terminal;
a second set of codes for causing the computer to determine, at the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application; and
a third set of codes for causing the computer to establish the communication link with the access terminal, prior to initiation of the at least one application on the access terminal, wherein the communication link includes the initial QoS parameters for the at least one application.

16. A network apparatus operable in configuring quality of service (QoS) for an access terminal, comprising:
means for receiving, at a network, a request for packet data access from an access terminal;
means for determining, by the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application; and
means for establishing the at least one reservation link with the access terminal, prior to initiation of the at least one application on the access terminal, wherein the at least one reservation link includes the initial QoS parameters for the at least one application.

17. A network apparatus operable for configuring quality of service (QoS) for an access terminal, comprising:
a receiver operable to receive a request for packet data access to a network from an access terminal;
a policy function operable to determine, at the network and based on establishment of the packet data access, an initial QoS policy configuration for at least one reservation link corresponding to at least one application on the access terminal, wherein the initial QoS policy configuration is based on preconfigured information and comprises initial QoS parameters for the at least one application; and
an access network operable to establish the at least one reservation link with the access terminal, prior to initiation of the at least one application on the access terminal, wherein the at least one reservation link includes the initial QoS parameters for the at least one application.

18. The apparatus of claim 17, further comprising an access gateway operable to associate the initial QoS policy configuration with a plurality of reservation links for a plurality of applications on the access terminal.

19. The apparatus of claim 18, wherein the access gateway is further operable to turn on the reservation upon establishment of the at least one reservation link by the access network.

20. The apparatus of claim 18, wherein the access gateway is further operable to turn off the reservation upon establishment of the at least one reservation link by the access network

21. The apparatus of claim 18, wherein the access network is further operable to receive a reservation link activation request from the access terminal or is operable to determine at the access network that the reservation link should be activated, and wherein the access gateway is further operable to turn on the reservation based on the reservation link activation request.

22. The apparatus of claim 21, wherein the reservation link activation request is based on a call originated by the access terminal.

23. The apparatus of claim 21, wherein the reservation link activation request is based on a call terminated by the access terminal.

24. The apparatus of claim 17, wherein the preconfigured information comprises subscriber information including a QoS user profile.

25. The apparatus of claim 24, wherein the policy function is further operable to derive the initial QoS parameters from the QoS user profile based on the access network used by the access terminal.

26. The apparatus of claim 17, wherein the initial QoS policy configuration comprises policy rules for the at least one application and each policy rule comprises at least one of full or partial packet filters and the initial QoS parameters for the at least one application.

27. The apparatus of claim 17, wherein the initial QoS parameters comprise at least one of maximum authorized aggregate bandwidth for best effort traffic, authorized flow profile IDs for each direction, maximum per flow priority, allowed differentiated services markings, inter-user priority for best effort, mapping between QoS class and Differentiated Services Code Point (DSCP), and mapping between QoS class and Token Bucket Parameters.

28. The apparatus of claim 17, wherein the policy function is further operable to determine the initial QoS policy configuration without receiving input from the access terminal.

29. The apparatus of claim 17, wherein the policy function is further operable to update the initial QoS configuration with new QoS parameters subsequent to establishing the communication link.
